(19) United States
(12) Patent Application Publication
(10) Pub. No.: US 2026/0244553 A1
(43) Pub. Date: Aug. 20, 2026

(54) TECHNIQUES TO FACILITATE LARGE LANGUAGE MODEL (LLM) HALLUCINATION DETECTION USING UNCERTAINTY ESTIMATION

(71) Applicant: Cisco Technology, Inc., San Jose, CA (US)

(72) Inventor: Samer M. Salam, Beirut (LB)

(21) Appl. No.: 19/055,097

(22) Filed: Feb. 17, 2025

(51) Int. Cl. G06F 11/3604

(52) U.S. Cl. CPC G06F 11/3608

(57) ABSTRACT

Provided herein are techniques to facilitate performing hallucination detection for function call text generated by a Large Language Model (LLM) through model confidence evaluation. In at least one embodiment, a method is provided that may include obtaining function call text generated by an LLM along with token information for one or more parameter slots of the function call text, calculating a UE metric for each slot name and each slot value of the function call text based on a UE metric type and the token information, and performing a comparison between the UE metric calculated for each slot name and each slot value to a UE metric threshold value. The method may further include determining whether each slot name and each slot value is hallucinated based on the comparison between the UE metric calculated for each slot name and each slot value to the UE metric threshold value.

### TECHNICAL FIELD

The present disclosure relates to network equipment and services for interfacing and/or interacting with Large Language Model (LLMs).

### BACKGROUND

Function calling is a useful feature for utilizing a Large Language Model (LLM) in which the LLM can classify an intent (of a user interacting with the LLM) and inform a system to invoke a function based on certain input data. Function calling for an LLM typically involves an LLM obtaining a user input or prompt, identifying a corresponding function and function parameters that are to be used to perform or execute the identified function, and providing a response to the user prompt that identifies the function to be called and the corresponding function parameters. The function can then be invoked using the function parameters.

Function calling can be useful in a variety of systems. However, the ability of an LLM to correctly identify a function and function parameters can be limited to the clarity of a user's input prompt. For example, in some instances, a function call may require a particular parameter that includes a specific value that an LLM is unable to determine or identify based on an erroneous or incomplete user input prompt. In such instances, the LLM can hallucinate or ‘make-up’ function parameters and/or function parameter values, which can lead to an erroneous function call being returned by the LLM that cannot be invoked. Such scenarios in which an LLM has hallucinated function parameters can lead to user frustration and/or other system errors/issues, which can limit the adoption or usability of the LLM.

### BRIEF DESCRIPTION OF THE DRAWINGS

FIG. 1A is a block diagram of a system that can be implemented to facilitate Large Language Model (LLM) hallucination detection based on uncertainty estimation, according to an example embodiment.

FIG. 1B is a diagram illustrating a function call structure for function calls that can be analyzed by the system of FIG. 1A in order to detect LLM hallucinations, according to an example embodiment.

FIG. 2 is a schematic diagram illustrating an example JavaScript Object Notation (JSON) object including an example function call along with tokens and token logarithmic (log) probabilities that can be utilized to perform hallucination detection in accordance with embodiments herein.

FIG. 3 is a flow chart depicting a method for identifying an optimal uncertainty estimator (UE) metric threshold value that can be used via the system of FIG. 1A to facilitate LLM hallucination detection, according to an example embodiment.

FIG. 4 is a plot illustrating example details associated with identification of a perplexity uncertainty estimator metric threshold value using the method of FIG. 3, according to an example embodiment.

FIG. 5 is a block diagram illustrating example operations that can be performed via the system of FIG. 1A to facilitate LLM hallucination detection, according to an example embodiment.

FIG. 6 is a chart illustrating experimental results associated with LLM hallucination detection that may be achieved using different uncertainty estimator metrics.

FIG. 7 is a flow chart depicting a method according to an example embodiment.

FIG. 8 illustrates a hardware block diagram of a computing device configured to perform functions associated with operations discussed in connection with embodiments herein.

### DETAILED DESCRIPTION

### Overview

Embodiments presented herein provide for the ability to perform hallucination detection through model confidence evaluation that can be facilitated using a model uncertainty estimator (UE) metric, such as a Perplexity UE metric, that can be calculated over a token sequence for one or more function parameters of a function call output by a Large Language Model (LLM) that is to be tested or analyzed for potential hallucination. In at least one embodiment, a calculated Perplexity metric for a particular function parameter of a particular function call (as output by the LLM), such as for a name of the function parameter and/or a value of the function parameter, can be compared against a Perplexity UE metric threshold value in order to determine whether the name and/or the value of the function parameter has been hallucinated by the LLM.

In at least one embodiment, the Perplexity UE metric threshold value can be set based on a process that involves maximizing an objective function. In at least one embodiment, the objective function can be defined such that it maximizes percentages of parameter values and parameter names that are correctly predicted as non-hallucinations by a UE metric threshold comparison and minimizes the percentages of parameter values and parameter names incorrectly predicted as non-hallucinations by the UE metric threshold comparison. In at least one embodiment, a plurality of candidate Perplexity UE metric threshold values can be evaluated to calculate objective function values corresponding to each candidate Perplexity UE metric threshold value in order to identify a particular UE metric threshold value that corresponds to a maximum value of the objective function.

In at least one embodiment, a computer-implemented method is provided that may include obtaining, from a large language model (LLM), function call text generated by the LLM and token information for one or more parameter slots of the function call text, wherein each parameter slot of the one or more parameter slots of the function call text includes a slot name and a slot value. The method may further include calculating an uncertainty estimator (UE) metric for each slot name and each slot value of the function call text based on a UE metric type and the token information and performing a comparison between the UE metric calculated for each slot name and each slot value to a UE metric threshold value. The UE metric threshold value can be determined based on the UE metric type and on an objective function that is defined to maximize percentages of slot values and slot names correctly predicted as non-hallucinations by a UE metric threshold comparison and to minimize percentages of slot values and slot names incorrectly predicted as non-hallucinations by the UE metric threshold comparison in which the UE metric threshold comparison is evaluated for a plurality of candidate UE metric threshold values. The method may further include determining whether each slot name and each slot value is hallucinated based on the comparison between the UE metric calculated for each slot name and each slot value to the UE metric threshold value.

### Example Embodiments

Many enterprise applications use generative artificial intelligence (AI) models, such as Large Language Models (LLMs) for function calling (also sometimes referred to as function-calling). Function calling refers to the ability of an LLM to deduce, from the user prompt, the correct function to execute (from a set of available functions) and the correct parameters to pass to that function. Instead of generating free-form text responses, an LLM for function calling is typically fine-tuned to return structured data, typically in a JavaScript Object Notation (JSON) format, often referred to as a JSON object. The returned structured data can be used to execute or invoke predefined functions, such as retrieving data from a data store, retrieving real-time data, calling arbitrary Application Programming Interfaces (APIs), and/or the like.

A typical problem often seen in function calling LLMs is that these models make up or ‘hallucinate’ values for the function parameters when said values are not supplied in a user's input prompt. Such hallucination can apply to both required function parameters as well as optional function parameters. This is especially problematic in scenarios where a function has optional parameters that are often omitted from the user prompt. Instructing the LLMs in a prompt for this scenario to use default values for missing parameters can improve model behavior but does not altogether eliminate such hallucinations. Other problems can arise when parameters are provided with values that are not understood by an LLM (e.g., the LLM is expecting a time based in minutes and a user inputs a time as “half an hour”, “within the last half hour”, or in seconds). As such, it would be advantageous to provide a mechanism or techniques through which function call hallucinations could be detected in order to improve the overall reliability of LLM-powered applications.

Embodiments herein provide techniques to facilitate hallucination detection of function parameters of a function call using uncertainty estimator metric techniques.

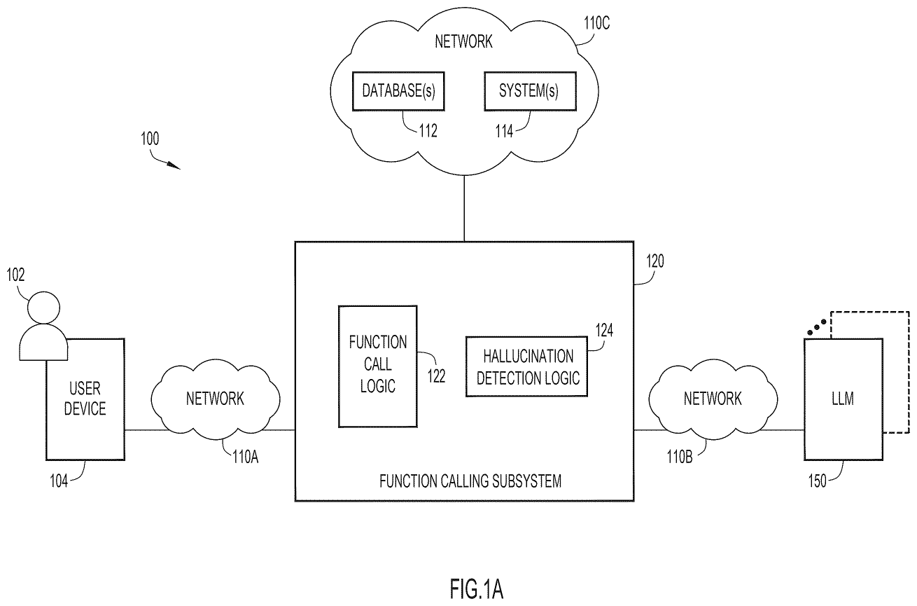

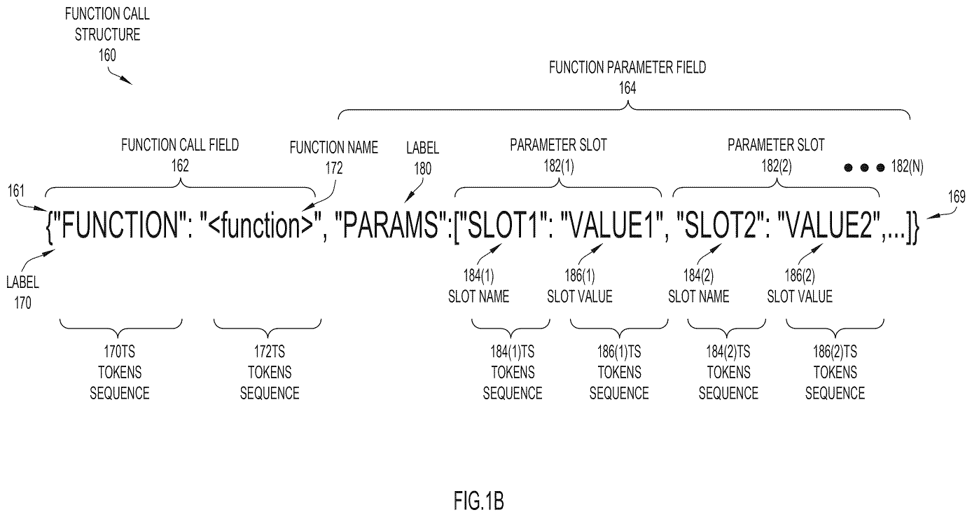

Referring to FIG. 1A, FIG. 1A is a block diagram of a system 100 that may be implemented to facilitate LLM hallucination detection of function call parameters based on uncertainty estimation, according to an example embodiment. In at least one embodiment, system 100 may include a function calling subsystem 120 and an LLM 150. Also shown in FIG. 1A are a user 102 that can operate a user device 104 in which the user device 104 may interface with the function calling subsystem 120 via a network 110A. The function calling subsystem 120 can further interface with the LLM 150 via a network 110B. Although only one LLM is illustrated in FIG. 1A, it is to be understood that function calling subsystem 120 can interface with any number of LLMs in accordance with embodiments herein and may facilitate functionality as discussed for embodiments herein with reference to LLM 150 for any number of LLMs.

The function calling subsystem 120 may include function call logic 122 and hallucination detection logic 124. The function calling subsystem 120 may further interface with one or more other networks, such as a network 110C, that may include one or more databases 112 and/or one or more systems 114 with which the function calling subsystem 120 can interact, perform one or more operations (e.g., based on user inputs (user prompts) provided by the user 102/user device 104, based on one of more function calls provided/invoked via interactions with LLM 150, etc.), manage, and/or the like in accordance with embodiments herein.

Generally, LLM 150 may represent any LLM/model that is capable of learning general representations of words/natural language that can be adapted to a wide range of downstream tasks, operations, etc., such as function calling.

Generally, user device 104 may be any computing device (e.g., laptop, desktop computer, etc.), mobile device (e.g., smart phone, tablet, etc.), cloud device (e.g., web portal/interface, etc.), logic, application, combinations thereof, and/or the like with which the user 102 may interact to provide one or more user inputs (e.g., input prompts, conversation inputs, etc.), which may be provided using any combination of input devices (e.g., keyboard, touchpad, microphone, etc.) and obtain one or more outputs via any combination of output devices (e.g., screen, speaker, etc.) for one or more interactions with function calling subsystem 120 and LLM 150. Such outputs can include, but not be limited to, output data, natural language conversational outputs, function call results, etc. that may be based on one or more function calls invoked via function calling subsystem 120 and LLM 150, that may be based on detection of a hallucinated function call output by LLM 150, and/or the like.

Broadly, during operation of system 100, the function calling subsystem 120 may receive a user input prompt provided by the user 102/user device 104, which can include natural language instructions/inputs, and can forward the user input prompt to LLM 150. The LLM 150 can identify a function call and one or more function call parameters that are to be used to invoke/execute the particular function call. The identified function call and function parameters can be returned to the function calling subsystem 120 that, via hallucination detection logic 124, can determine whether one or more function parameters of the received function call have been hallucinated by the LLM 150. Based on the determination (e.g., parameter(s) have been hallucinated or parameter(s) have not been hallucinated) the hallucination detection logic 124 can interact with function call logic 122 to trigger one or more other operations, as discussed in further detail herein.

Embodiments herein may be particularly useful for detecting LLM hallucination for scenarios in which an LLM has hallucinated parameter value(s) for a generated function call when said value(s) are not provided in the user's input prompt, which can affect the accuracy of the parameter value filling capacity of the LLM.

A starting point for hallucination detection as provided by embodiments herein is the intuition that model uncertainty can be used to detect hallucinations. In at least one embodiment, system 100 may facilitate hallucination detection for function call(s) output by LLM 150 through model confidence evaluation using a model uncertainty estimator (UE) metric computed over a token sequence (also referred to herein as ‘tokens sequence’) for a function parameter of a function call output by LLM 150 that is to be tested for hallucination.

With reference to FIG. 1B, FIG. 1B illustrates a function call structure 160 for function calls that may be generated/output by an LLM, such as LLM 150, in which such a function call can be analyzed by the system 100 of FIG. 1A in order to detect LLM hallucinations for one or more function parameters of a function call.

In at least one embodiment, various fields, names, values, etc. for a function call output by LLM 150 in accordance with the function call structure 160 may be formatted as structured data in accordance with a JSON format for a JSON object that can be ingested and analyzed via hallucination detection logic 124 of function calling subsystem 120 in order to detect whether one or more function parameters of function calls output by LLM 150 have been hallucinated.

As illustrated in FIG. 1B, the function call structure 160 can include a function call field 162 and a function parameter field 164 in which the entirety the given function call structure 160, from the opening bracket ‘{’ (labeled 161) to the closing bracket ‘}’ (labeled 169) is considered text a given function call generated by the LLM.

Text, which can include any text characters (e.g., alphanumeric, symbols, etc.) provided or filled-in/filled for different elements of each of the function call field 162 and the function parameter field 164 can be made of a sequence of one or more tokens generated the LLM 150, referred to herein as a ‘tokens sequence’.

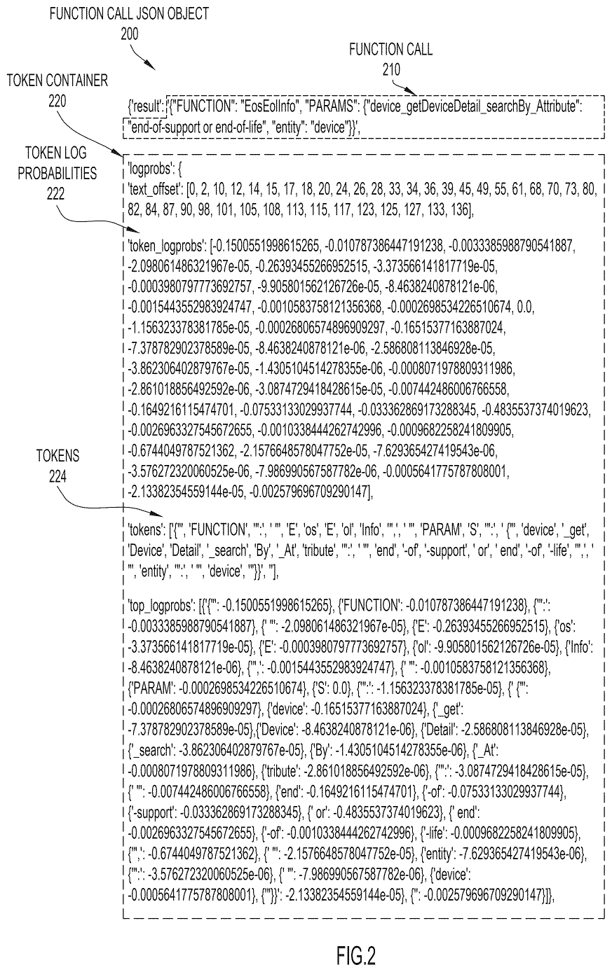

Different LLMs can have different tokenization schemes for the elements (e.g., function call and function parameters) of function calls output by a given LLM, however, embodiments herein do not depend on the specific tokenization scheme of a given LLM for determining whether one or more parameters of a function call output by an LLM have been hallucinated, as many LLMs provide details regarding the tokens (text) generated for a given function call that is provided in the JSON output (JSON object) for the function call. FIG. 2, discussed in further detail below, illustrates an example JSON object that may be generated by an LLM for a given function call generated by the LLM in which the JSON object can be ingested/obtained by hallucination detection logic 124 for performing hallucination detection in accordance with embodiments herein.

Returning to FIG. 1B, the function call field 162 may include a label field 170 that precedes a function name field 172. The label field 170 being set to “FUNCTION” can be used to indicate that the following function name field 172 includes a name for a corresponding function call, such as “<function>” for the example shown in FIG. 1B. The text provided/filled by the LLM 150 for the label field 170, such as the “FUNCTION” label, consists of one or more tokens (e.g., a tokens sequence), labeled 170TS and the text provided/filled by the LLM 150 for the function name field, such as the “<function>” function name, may also consist of a tokens sequence, labeled 172TS.

The function parameter field 164 may include a label field 180 that precedes an ‘N’ number of parameter slots, such as a parameter slot 182(1) for a first function parameter that may be provided or ‘filled’ by the LLM 150, a second parameter slot 182(1) for a second function parameter that may be filled by the LLM 150, and so on, through a parameter slot 182(N) for an ‘N’ number of function parameters that may be provided/filled by the LLM 150 for a corresponding function call.

Each corresponding parameter slot 182(1)-182(N) includes a corresponding slot name field (also referred to herein as a parameter name) and a slot value field (also referred to herein as a parameter value). For example, parameter slot 182(1) includes a slot name field 184(1) that can be filled with a slot name of “SLOT1” that consists of a tokens sequence 184(1) TS and a slot value field 186(1) that can be filled with a slot value of “VALUE1” that consists of a tokens sequence 186(1) TS. Similarly, parameter slot 182(2) includes a slot name field 184(2) that can be filled with a slot name of “SLOT2” that consists of a tokens sequence 184(2) TS and a slot value field 186(2) that can be filled with a slot value of “VALUE2” that consists of a tokens sequence 186(2) TS.

As noted above, embodiments herein may facilitate model confidence evaluation using a model uncertainty estimator (UE) metric computed over a tokens sequence for a function parameter output function call that is to be tested for hallucination. More specifically, embodiments herein may provide for the ability to estimate a model's uncertainty or, stated differently, the confidence of LLM 150 in the text generated by the LLM for a given function call output by the LLM 150, based on the conditional probability, typically a logarithmic (log)-based probability, of the tokens generated by the LLM 150 for a given tokens sequence of one or more field(s) of the function call that are to be tested for potential hallucination.

For instance, in at least one embodiment, hallucination detection logic 124 may facilitate determining whether a corresponding slot name and/or a corresponding slot value of one or more corresponding parameter slots 182(1)-182(N) of a given function call output by LLM 150 has been hallucinated by calculating a UE metric using the conditional probabilities (output/provided by the LLM 150) for the corresponding tokens sequence of the corresponding slot name/slot value for particular UE metric type.

The calculated UE metric for a corresponding slot name/slot value is then compared to a UE metric threshold value to determine whether the threshold value is breached or crossed. As discussed in further detail herein, the UE metric threshold value can be determined based on a UE metric type and on an objective function that is defined to maximize percentages of slot values and slot names correctly predicted as non-hallucinations by a UE metric threshold comparison and to minimize percentages of slot values and slot names incorrectly predicted as non-hallucinations by the UE metric threshold comparison in which the UE metric threshold comparison is evaluated over multiple candidate UE metric threshold values. For some UE metric types, the threshold value can be considered to be breached or crossed if a calculated UE metric for a given slot name/slot value is greater than the threshold value and for other UE metric types, the threshold value can be considered to be breached or crossed if a calculated UE metric for a given slot name/slot value is less than the threshold value.

For example, in order to deduce whether “VALUE1” in the example of FIG. 1B is hallucinated or not, a UE metric, for example ‘UE (VALUE1)’, can be calculated (for a particular UE metric type) using the tokens sequence 186(1) TS by hallucination detection logic 124. A comparison can be performed between the UE metric, UE (VALUE1), a UE metric threshold value, for example ‘UE_THRESH’. In one example, if the UE metric UE (VALUE1) is greater than UE_THRESH, then hallucination detection logic 124 can determine that the LLM 150 has hallucinated the value of “VALUE1”. Otherwise, if UE (VALUE1) is less than UE_THRESH, then hallucination detection logic 124 can determine that the value is correct and can be used for function calling (e.g., via function call logic 122).

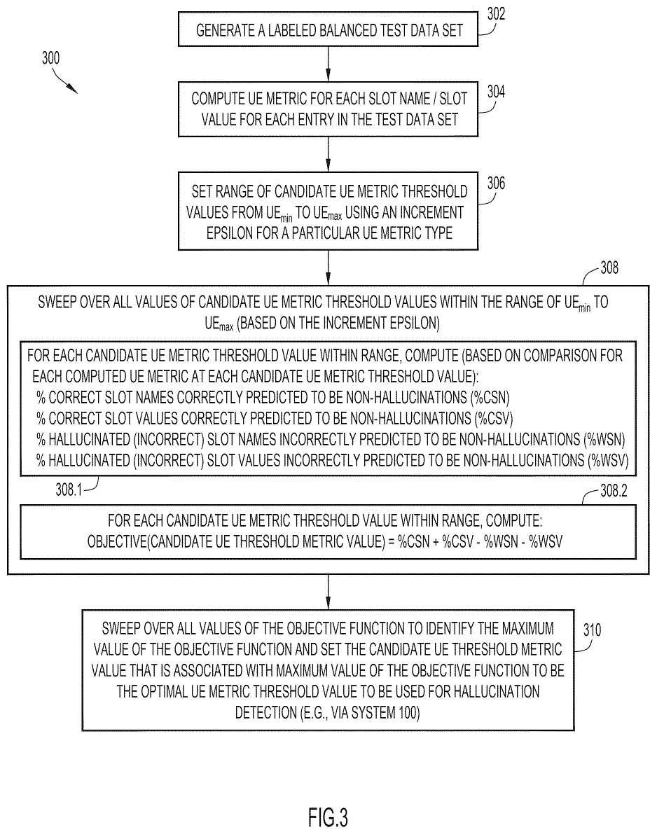

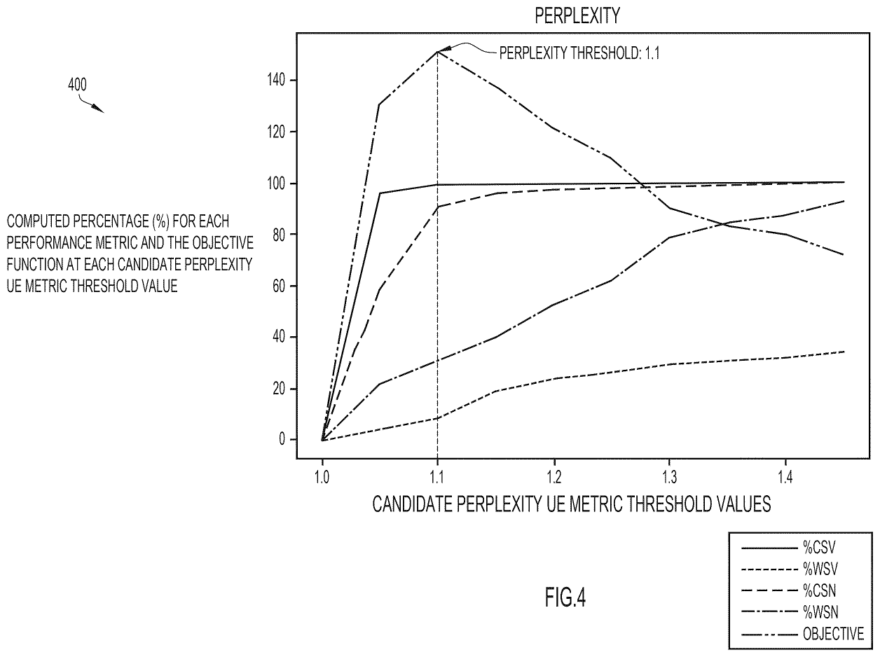

Techniques for determine a UE metric threshold value are discussed in further detail herein below with reference to FIGS. 3 and 4.

In at least one embodiment, a UE metric type that may be utilized by hallucination detection logic 124 for detecting whether at least one slot name and/or slot value of at least one parameter of a function call generated by LLM 150 has been hallucinated is the model Perplexity UE metric type. For the Perplexity (PPL) UE metric type, PPL for a particular tokens sequence (e.g., of a particular slot name or of a particular slot value of a particular parameter slot) can be calculated as shown in Equation 1, below.

$$Perplexity ( PPL ) = {e}^{Average NLL} \qquad Equation 1$$

For Equation 1, Average NLL is the Average Negative Log Likelihood (NLL), or the negative Length-normalized Sequence Log Probability, of the particular tokens sequence (e.g., of a particular slot name or of a particular slot value of a particular parameter slot) that can be calculated as shown in Equation 2, below.

$$Average NLL = \frac{- 1}{L} {\sum }_{k = 1}^{L} log P ( {y}_{k} \vert y < k ) \qquad Equation 2$$

For Equation 2, L is the length of the particular tokens sequence and ‘log P(yₖ|y<k)’ is the log of the conditional probability of each k^{th} token of the particular tokens sequence given all past generated tokens up to and including the (k−1)th token. The log probability (log P) of each token of a tokens sequence can be provided/output by a given LLM, such as LLM 150, for a particular function call output by the LLM as a byproduct of the text generation performed by the LLM. Log probabilities are typically used by an LLM's output sampling algorithm to determine a ‘next’ generated token for the text generated/output by the LLM.

In order to better illustrate token log probabilities for a generated function call that may be output by an LLM, consider FIG. 2, which is a schematic diagram illustrating an example function call JSON object 200 including an example function call 210 (‘result’), also referred to as the function call output string, along with a token container 220 (‘logprobs’) including an array of token log probabilities 222 (‘token_logprobs’) for tokens 224 (‘tokens’) of the corresponding function call 210.

For the example of FIG. 2, consider that a user input is provided to the LLM, as follows:
Question: Could you provide details regarding the end-of-support or end-of-life status for the device?

Various token information can be included in the token container 220, such as text offset information (‘text_offset’) (not labeled) that indicates the start location of each token 224 in the generated function call 210 output text string. The token container 220 can also include information, such as ‘top_logprobs’, which can be useful if output sampling is enabled for an LLM. For example, if output sampling for an LLM is enabled, the ‘top_logprobs’ can indicate the log probabilities of the top_p tokens that were fed to the sampling process in order to select each token by the LLM. However, for instances in which output sampling for an LLM is disabled, the ‘top_logprobs’ and the token log probabilities for the tokens will be the same, as shown in FIG. 2.

With reference to FIG. 2, the PPL UE metric for a parameter slot value, such as “end-of-support or end-of-life” for the parameter name “device_getDeviceDetail_searchBy_Attribute”, can be calculated according to Equations 1 and 2, above, using the corresponding ‘token_logprobs’ of the tokens sequence: ‘end’, ‘-of’, ‘-support’, ‘or’, ‘end’, ‘-of’, ‘-life’ (as identified in the token container 220, which includes 7 tokens or L=7), as follows:

$$Average NLL = - 1 / 7 [ ( - 0.1649216115474701 ) + ( - 0.07533133029937744 ) + ( - 0.033362869173288 \; 345 ) + ( - 0.4835537374019623 ) + ( - 0.0026963327545672655 ) + ( - 0.0010338444262742996 ) + ( - 0.0009682258241809905 ) ] = 0.1088382 \; 78775$$

$$PPL ( end - of - support or end - of - life ) = {e}^{0.108838278775} = 1.11449820195$$

Following the PPL UE metric calculation for the parameter slot value, a comparison to a PPL UE metric threshold value, say 1.1, in order to determine whether the parameter slot value has been hallucinated by the LLM. For the PPL UE metric, a parameter slot name or parameter slot value is considered to have been hallucinated if the calculated UE metric for the tokens sequence of the parameter slot name/value is greater than 1.1. Thus, in this example, the parameter slot value, “end-of-support or end-of-life” would be detected (e.g., by hallucination detection logic 124) as being hallucinated (e.g., PPL (end-of-support or end-of-life: 1.11449820195)>1.1 (PPL UE metric threshold value).

In order to determine a UE metric threshold value for a particular UE metric type, such as the PPL UE metric type, four model performance metrics for LLM function calling can be defined in accordance with embodiments herein, such as:
% Generations with Correct Slot Names (% CSN)
% Generations with Wrong Slot Names (% WSN)
% Generations with Correct Slot Values (% CSV)
% Generations with Wrong Slot Values (% WSV)

The distribution of each of the performance metrics can be examined as a function of the UE metric, which can be used to define an objective function, as follows:

$$Objective = \% Gen w . Correct Slot names + \% Gen w . Correct Slot Values - \% Gen w . Wrong Slot Names - \% Gen w . Wrong Slot Values$$

The objective function is defined to maximize the percentages of slot values and slot names correctly predicted as non-hallucinations by a UE metric threshold comparison and to minimize the percentages of slot values and slot names incorrectly predicted as non-hallucinations by the UE metric threshold comparison.

Stated differently, the objective function is defined to maximize the percent of slot names and slot values of a test data set that are correctly predicted (based on a comparison between calculated UE metrics for the slot names and slot values of the test data set to a particular UE metric threshold value) to be correct (not hallucinated) that are known to be correct (not hallucinated) [based on a priori knowledge or a ground truth of which slot names/values for function calls of the each entry of the test data set are correct (not hallucinated) and which are incorrect (hallucinated)] and to minimize the percent of slot names and slot values of the test data set that are incorrectly predicted to be non-hallucinations that are known to be hallucinations (for example, based on the comparison to the particular UE metric threshold value, the result would be incorrectly predicting that the slot names/values are not hallucinated (correct), when it is known that they are hallucinated (incorrect)).

For determining a particular UE metric threshold value that is to be utilized by the hallucination detection logic 124 during operation of system 100, the goal is to determine a particular UE metric threshold value that maximizes the above objective function.

With reference to FIG. 3, is a flow chart depicting a method 300 for determining an optimal uncertainty estimator (UE) metric threshold value that can be used via the system 100 of FIG. 1A to facilitate LLM hallucination detection, according to an example embodiment.

As illustrated in FIG. 3, a labeled balanced test data set is generated at 302. Each entry in the test data set includes an input prompt, a resultant function call generated by an LLM (in a JSON object format, including token information), and a ground truth (GT) for the function call that indicates the correct values for slot names and slot values. In the case where the slot value is missing (not available in the input prompt), the ground truth indicates so by marking it as N/A or null or using any other designation. The test data set is considered ‘balanced’ in that it is to include an approximately equal number of entries having correct slot names/values as entries having incorrect slot names/values. The test data set is considered ‘labeled’ in that it includes the ground truth of the correct slot names/values, or a clear designation if the slot value is missing (cannot be determined).

As shown at 304, a UE metric is computed (calculated) for each parameter slot name and slot value of each function call for each entry of the test data set (e.g., using the JSON object token log probabilities) for a particular UE metric type that is selected/set for use for the method 300. For example, a PPL UE metric can be calculated for each slot name and each slot value of each function call for each entry of the test data set using Equations 1 and 2, as noted above. Other UE metrics can be utilized for the calculation, such as a Sequence Log Probability (Logprob) UE metric, a Sequence Probability (SeqProb) UE metric, a Length-normalized Sequence Log Probability (Seq-Logprob) UE metric, or a Length-normalized Sequence Probability (SeqProb-Normalized), as shown below:

$$Logprob = {\sum }_{k = 1}^{L} log P ( {y}_{k} \vert y < k )$$

$$SeqProb = {e}^{Logprob}$$

$$Seq - LogProb = \frac{1}{L} {\sum }_{k = 1}^{L} log P ( {y}_{k} \vert y < k )$$

$$SeqProb - Normalized = {e}^{S e q - Logprob}$$

Next, a range of candidate UE metric threshold values from a UEₘᵢₙ to a UEₘₐₓ is set using an increment epsilon for a particular UE metric type, as shown at 306. For example, for the PPL UE metric type, UE values are typically greater than 1.0 (e.g., may range between 1.0 and 9.0, with the upper bound being dependent on the LLM being utilized). However, for another metric type, such as the Length-normalized Sequence Probability (SeqProb-Normalized) UE metric type, UE values typically range between 0.0 and 1.0. Thus, the range of candidate UE metric threshold values can be set based on the UE metric type for which hallucination detections are to be performed for a system (e.g., system 100 of FIG. 1A).

Generally, the more granular that the increment epsilon is, the better results may be for hallucination detection. In at least one embodiment, the increment epsilon can be set to 0.05 such that for a range between 1.0 and 9.0 for the PPL metric type, 160 candidate UE metric threshold values can be analyzed in order to identify an optimal UE metric threshold value to be utilized for hallucination detection for a system.

As shown at 308, an iterative process is performed that includes sweeping over all of the candidate UE threshold metric values within the range of UEₘᵢₙ to UEₘₐₓ (based on the increment epsilon. As shown at 308.1, a comparison is performed between each computed UE metric for each slot name and each slot value for each function call entry in the data set and each of a particular candidate UE threshold metric value to determine whether each slot name and each slot value would be predicted or ‘marked’ as correct (not hallucinated) or incorrect (hallucinated) based on the comparison.

The outcome of the comparison, such as whether a slot name or slot value would be predicted or ‘marked’ as correct or incorrect, depends on the UE metric type selected for the method 300. For example, for a PPL UE metric type, if a computed PPL UE metric, say, for a slot name, is found to be less than a particular candidate PPL UE metric threshold value, then the slot name would be predicted to be correct (not hallucinated), whereas if the computed PPL UE metric for the slot name is found to be greater than the particular PPL candidate UE metric threshold, then the slot name would be predicted to be incorrect (hallucinated).

However, if the Length-normalized Sequence Probability (SeqProb-Normalized) UE metric were selected for method 300, if a computed SeqProb-Normalized UE metric, for example for a slot value, is found to be greater than a particular candidate SeqProb-Normalized UE metric threshold value, then the slot value would be predicted to be correct (not hallucinated), whereas if the computed SeqProb-Normalized UE metric for the slot value is found to be less than the particular candidate SeqProb-Normalized UE metric threshold value, then the slot value would be predicted to be incorrect (hallucinated).

For the operations at 308.1, each prediction for entry in the test data set can be checked for its veracity or ‘correctness’ using the ground truth for each entry to identify whether each slot name and each slot value for each function call is actually correct (non-hallucinated) or incorrect (hallucinated).

Using the ground truth (GT) for each entry for each particular candidate UE threshold metric value, percentages can be computed for each performance metric, as follows:
The percentage of correct slot names that were correctly predicted to be non-hallucinations (% CSN), according to the following algorithm:

$$\% CSN = \frac{\# Slot Names predicted to be correct and are correct per GT}{\# Total entries in data set} * 100$$

The percentage of correct slot values that were correctly predicted to be non-hallucinations (% CSV), according to the following algorithm:

$$\% CSV = \frac{\# Slot Names predicted to be correct and are correct per GT}{\# Total entries in data set} * 100$$

The percentage of hallucinated (incorrect) slot names that were incorrectly predicted to be non-hallucinations (% WSN), according to the following algorithm:

$$\% WSN = \frac{\# Slot Names predicted to be correct and are incorrect per GT}{\# Total entries in data set} * 100$$

The percentage of hallucinated (incorrect) slot values that were incorrectly predicted to be non-hallucinations (% WSV), according to the following algorithm:

$$\% WSV = \frac{\# Slot Values predicted to be correct and are missing per GT}{\# Total entries in data set} * 100$$

Further, as shown at 308.2, for each candidate UE metric threshold value, a corresponding value of the objective function can be computed, as:

$$Objective ( Candidate UE metric threshold value ) + \% CSN + \% CSV - \% WSN - \% WSV$$

Each value of the objective function for each candidate UE metric threshold value can be stored for further processing. For example, as shown at 310, the method can include sweeping over all values of the objective function computed for each candidate UE metric threshold value in order to identify the maximum value of the objective function and setting the candidate UE metric threshold value that corresponds to the maximized objective function value to be the optimal UE metric threshold value that is to be used for hallucination detection for the system (e.g., system 100 of FIG. 1A).

Consider a numerical example for calculating each of % CSN, % CSV, % WSN, % WSV in which there are 1300 questions that result in the generation of function calls with a total number of 800 parameter slots being filled per the GT. In this example, consider that, for comparisons involving a particular candidate UE threshold metric value and corresponding calculated UE metrics, 620 slot names were predicted to be correct and, per the GT, were actually correct such that % CSN=620/800*100=77.5%. A similar calculation can be performed for % CSV based on the predictions and GT for slot values. Moving to % WSN, consider that 200 slot names are actually hallucinations per the GT. Out of those 200, consider that the 20 were incorrectly predicted to be correct for the given candidate UE threshold metric value/calculated UE metric comparisons when, in fact (per the GT), they were known to be hallucinations. In this case, % WSN=20/800*100=2.5%. A similar calculation can be performed for % WSV, say, if the GT indicates that 100 slot values are hallucinations but, per the candidate UE threshold metric value/calculated UE metric comparisons, 15 were incorrectly predicted to be correct, then % WSV=15/800*100=1.875%.

Thus, as illustrated in FIG. 3, an iterative process can be performed using a test data set over a range of candidate UE metric threshold values in order to identify an optimal UE metric threshold value for a particular UE metric type that, for the defined objective function, maximizes the percentages of slot values and slot names correctly predicted as non-hallucinations by the UE metric threshold comparison and minimizes the percentages of slot values and slot names incorrectly predicted as non-hallucinations by the UE metric threshold comparison.

Referring to FIG. 4, FIG. 4 is a plot 400 illustrating example details associated with identifying a PPL UE metric threshold value using the method of FIG. 3, according to an example embodiment. Specifically, in the example embodiment, plot 400 was generated using the open source Llama3.1-Instruct LLM and two balanced and labeled test data sets, each including over 1300 input prompts (questions) for function calling.

For the plot 400, the X-axis represents a range of candidate PPL UE metric threshold values and the Y-axis represents computed percentages for each of % CSV (correct slot value), % WSV (wrong slot value), % CSN (correct slot name), % WSN (wrong slot name), and the overall value of the objective function (as calculated according to each % CSN+% CSV-% WSN-% WSV) for each candidate PPL UE metric threshold value.

As illustrated in FIG. 4, utilizing the method 300, it is shown that a PPL UE metric threshold value of 1.1 may be the optimal PPL UE metric threshold value to utilize for hallucination detection operations such that (for the PPL UE metric type), any PPL UE metric calculated for any tokens sequence of any parameter slot name or parameter slot value that is greater than 1.1 can safely be marked as a hallucination by a particular LLM (e.g., LLM 150).

For example, if [Calculated UE metric (slot name/value)]>PPL UE metric threshold value, then the corresponding slot name/value is identified (base hallucination detection logic 124) as being hallucinated by the particular LLM.

Upon determining or setting the UE metric threshold value for a particular UE metric type for a system, such as system 100, hallucination detections for function calls generated by an LLM can be performed in accordance with embodiments herein.

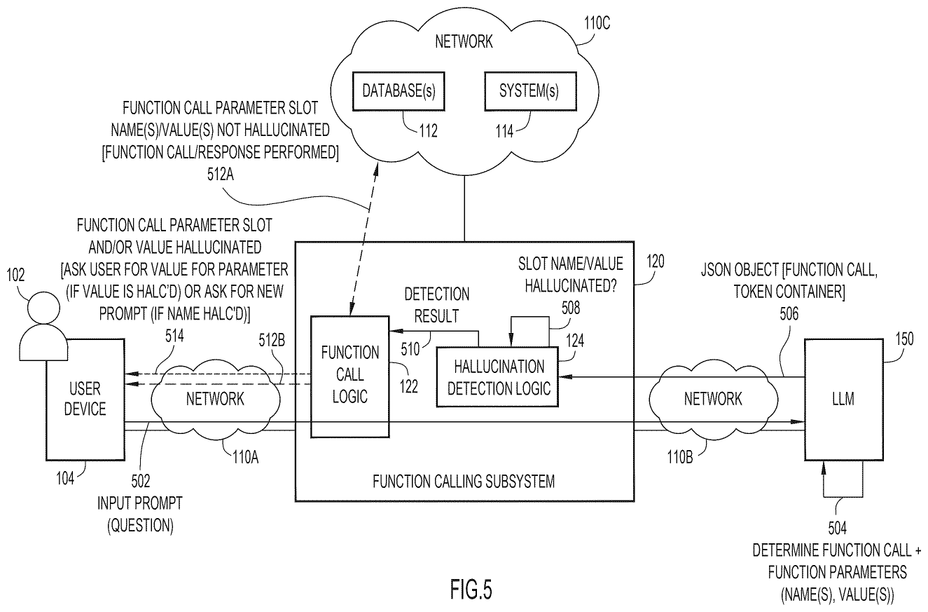

With reference to FIG. 5, FIG. 5 is a block diagram illustrating example operations that can be performed via the system 100 of FIG. 1A to facilitate LLM hallucination detection, according to an example embodiment. For the embodiment of FIG. 5, consider that a PPL UE metric type is to be utilized by system 100 to perform LLM hallucination detections and that the PPL UE metric threshold value for the system 100 is set to 1.1.

For example, as shown at 502, consider that an input prompt or question is provided by user 102 via user device 104 in which the input prompt is passed/routed, via function calling subsystem 120 (potentially via function calling logic 122), to LLM 150.

As shown at 504, LLM 150 determines and generates a function call to invoke along with corresponding function call parameters, each parameter including a corresponding name, in which the generated function call and parameters are encoded within a JSON object that includes the generated function call text and a token container including, at least tokens and token log probabilities corresponding to the generated function call text.

As shown at 506, LLM 150 transmits the JSON object including the generated function call text and the token container to the function calling subsystem 120 in which the JSON object is obtained or otherwise ingested by hallucination detection logic 124.

As generally illustrated at 508, hallucination detection logic 124 can calculate a PPL UE metric for each tokens sequence of each parameter slot name and each parameter slot value included in the function call text through operations as discussed for embodiments herein. Further at 508, hallucination detection logic 124 can perform a comparison between each calculated PPL UE metric for each slot name and each slot value and the PPL UE metric threshold value of 1.1 in order to determine whether any slot name(s)/value(s) of the function call text have been hallucinated by the LLM 150.

As noted herein for the PPL UE metric type, hallucination detection logic 124 can detect that a corresponding slot name or slot value is incorrect (hallucinated) if the calculated PPL UE metric for the tokens sequence of the corresponding slot name or slot value is greater than 1.1; otherwise, hallucination detection logic 124 can mark/identify a corresponding slot name or slot value as correct (not hallucinated) if the calculated PPL UE metric for the tokens sequence of the corresponding slot name or slot value is less than 1.1.

Based on the operations performed at 508, hallucination detection logic can generate a detection result, as shown at 510, and provide the detection result along with the JSON object to function call logic 510, which can determine one or more subsequent operations based on the detection result.

In one example, upon obtaining a detection result indicating that the parameter slot name(s) and the parameter slot value(s) for the function call generated by LLM 150 have not been hallucinated, function call logic 122 can execute the function call towards the corresponding database(s) 112 and/or system(s) 114 and provide an output/result of the function call operations to the user device 104/user 102, as generally shown at 512A and 512B.

In another example, upon obtaining a detection result indicating that a particular parameter slot name and/or a particular parameter slot value for the function call generated by LLM has been hallucinated, function call logic 122 can perform one or more additional operations to attempt to obtain additional information and/or prompt(s) from the user 102, as generally shown at 514.

For example, if it is determined that a parameter slot value has been hallucinated by the LLM 150, function call logic 122, potentially through a dialog manager/logic (not shown), can generate a request towards user device 104/user 102 requesting the user 102 to provide an appropriate value for a particular parameter name. In another example, if it is determined that a parameter slot name has been hallucinated by the LLM 150, function call logic 122, potentially through the dialog manager, can generate a request towards user device 104/user 102 requesting the user 102 to provide a new prompt/question to trigger another function call output from the LLM. Other variations these operations can be envisioned.

Although the PPL UE metric type is discussed for the example of FIG. 5, it is to be understood that any UE metric types may be utilized to facilitate LLM hallucination detection in accordance with embodiments herein, under the basis of identifying an optimal UE metric threshold value for a particular UE metric type utilizing the method 300 of FIG. 3 in order to maximize the objective function that seeks to maximize the percentages of slot values and slot names correctly predicted as non-hallucinations by a UE metric threshold comparison and to minimize the percentages of slot values and slot names incorrectly predicted as non-hallucinations by the UE metric threshold comparison.

Further, embodiments herein may facilitate post-hoc hallucination detection that can be applied to any pre-trained or fine-tuned LLM that is capable of function calling. As such, processes of model fine-tuning, data curation, and evaluation can leverage any of the existing state-of-the-art techniques without preclusion. Moreover, optimal UE metric threshold value determination for use with hallucination detection in accordance with embodiments herein can be derived post-hoc from an LLM with frozen model weights without requiring access to the training/fine-tuning data set of the LLM and without assuming any knowledge of the fine-tuning technique performed for the LLM.

While several output guardrail mechanisms exist for managing LLM function calling outputs, none of these mechanisms may provide the necessary accuracy in detecting LLM hallucinations, specifically for scenarios in which an LLM hallucinates parameter value(s) when said value(s) are not provided in a user's input prompt.

Such guardrail mechanisms can include context grounding, text matching, access list filtering, and judge LLM. The intuition behind context grounding is that the response generated by an LLM needs to be grounded in factual data retrieved from the LLM's vector database. This grounding implies that there is to be a high degree of semantic alignment between the generated output of the LLM and the context provided in the input prompt. Context grounding is implemented using semantic similarity analysis over response and context embedding vectors. In other words, a response generated by the LLM is embedded into a vector representation. The semantic similarity (e.g., cosine similarity) is then computed between the response embedding and the embedding vector of each of the top K chunks retrieved from the vector database in a Retrieval-Augmented Generation (RAG) pipeline. The maximum value of these pairwise similarity comparisons is then computed. If this maximum value drops below a threshold value, then the generated response is filtered by the guardrail.

For the text matching guardrail mechanism, the text of the original user prompt is subjected to pattern matching in search of the value of a parameter that the LLM selected. If the value does not appear in the user's prompt, then it is assumed that the value was a hallucination. This approach fails when the parameter value filling involves some form of unit conversion (e.g., user prompt indicates “in the past half hour” and the value of the parameters is filled in as “30 minutes”). The access list guardrail mechanism does not apply to function calling scenarios since the access list guardrail mechanism involves searching an LLM's output for specific keywords that trigger filtering. Such access list guardrail mechanisms cannot detect hallucination in parameter value filling. For the judge LLM guardrail mechanism, a second LLM is used to judge if a first LLM's output contains any hallucination. However, this mechanism is not pragmatic for two reasons: its reliability remains questionable, and the latency/cost associated with having two daisy-chained LLMs can be significant.

As such, the hallucination detection techniques as provided through embodiments herein remain the preferred approach to address function calling hallucinations, in particular, parameter slot value hallucinations with a high degree of precision/recall.

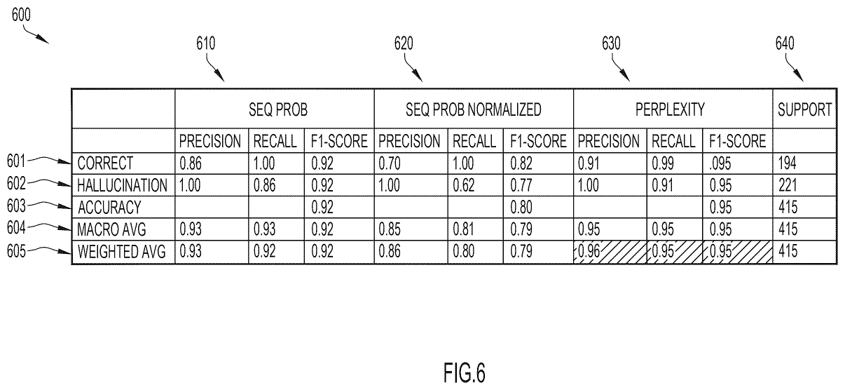

Moving to FIG. 6, FIG. 6 is a chart 600 illustrating experimental results associated with LLM hallucination detection that may be achieved using different uncertainty estimator metric types. For example, chart 600 illustrates experimental results including certain statistical values, such as Precision, Recall, and F1-Score that can be calculated and utilized to evaluate the performance of different UE metric types that may be considered for detecting LLM hallucinations.

The different UE metric types evaluated for the chart 600 include statistical values 610 calculated for the Sequence Probability (Seq Prob) UE metric type, statistical values 620 calculated for the Length-normalized Sequence Probability (Seq Prob Normalized) UE metric type, and statistical values 630 calculated for the Perplexity UE metric type.

The statistical values for each UE metric type are calculated for a test data set involving a balanced data set of 415 questions, with roughly equal numbers of hallucinated and correct slot values, as illustrated in the Support column 640 of chart 600.

For the chart 600, consider a brief explanation for statistical values calculated/illustrated for each of the ‘Correct’ row 601 values and the ‘Hallucination’ row 601 values for each of Precision, Recall, and F1-Score with reference to the statistical values 630 for the Perplexity UE metric type.

For example, the Precision value calculated for the ‘Correct’ row 601 indicates that for each parameter slot name/value that the hallucination detection logic 124 as provided through embodiments herein predicted to be correct (for a given UE metric type and optimally selected/set UE metric threshold value, such as 1.1), 0.91 or 91% of those slot names/values were known to be correct. Stated differently, in some instances, i.e., 9% of the time, the detection logic predicted that a slot name/value was correct when it was known hallucinated. The Precision value calculated for the ‘Hallucination’ row 602 indicates that for each parameter slot name/value that the hallucination detection logic predicted were hallucinated, 100% of those slot names/values were known to be hallucinated.

Moving to the Recall results, the Recall value calculated for the ‘Correct’ row 601 indicates that out of all the slot names/values that were known to be correct, the hallucination detection logic predicted 99% of those as being correct. The Recall calculated for the ‘Hallucination’ row 602 indicates that of all the outputs that were known to be hallucinated, the hallucination detection logic predicted 91% of those as hallucinations (thus, the detector missed some outputs that were actually hallucinated).

F1-Score is merely a combination of Precision (P) and Recall (R) that is calculated as (P+R)/(P*R). For the other statistical values, such as values for the ‘Accuracy’ row 603 can be calculated as an average of the F1-Score for both Correct and Hallucination results, values for the ‘Macro Avg’ (average) row 604 for each of Precision and Recall can be calculated as the average of each corresponding column, and values for the ‘Weighted Avg’ row 605 can be calculated by multiplying the metric of a given row by its number of occurrences (support) and dividing over the total number.

As shown in chart 600, the experimental results confirm that the Perplexity UE metric type is the best UE metric to be used with the LLM that generated the outputs for this experiment. For a different LLM or a different set of questions/context, the best UE metric may be different, which would involve re-running the objective function, for example, performing the operations of FIG. 3 for different UE metric types, in order to determine which metric type and which metric threshold value produces the best results in terms of Precision/Recall/F1-score.

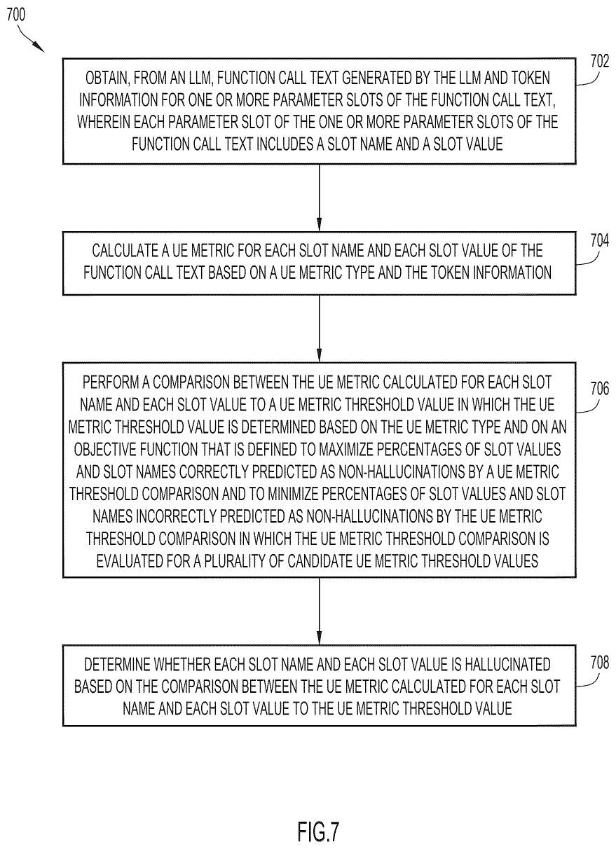

Referring to FIG. 7, FIG. 7 is a flow chart depicting a method 700 according to an example embodiment. In at least one embodiment, method 700 illustrates operations that may be performed at least in part by a function calling subsystem, such as function calling subsystem 120 via hallucination detection logic 124, according to an example embodiment.

A 702, the method may include obtaining, from an LLM (e.g., obtaining by function calling subsystem 120 via hallucination detection logic 124 from LLM 150), function call text generated by the LLM and token information for one or more parameter slots of the function call text in which each parameter slot of the one or more parameter slots of the function call text includes a slot name and a slot value.

At 704, the method may include calculating an uncertainty estimator (UE) metric for each slot name and each slot value of the function call text based on a UE metric type and the token information. For example, the UE metric calculated for each slot name and each slot value can be calculated according to the UE metric type, such as the PPL metric type, including token information included in a token contain of a JSON object obtained from the LLM for the generated function call text, as discussed for embodiments herein.

At 706, the method may include performing a comparison between the UE metric calculated for each slot name and each slot value to a UE metric threshold value in which the UE metric threshold value is determined based on the UE metric type and on an objective function that is defined to maximize percentages of slot values and slot names correctly predicted as non-hallucinations by a UE metric threshold comparison and to minimize percentages of slot values and slot names incorrectly predicted as non-hallucinations by the UE metric threshold comparison in which the UE metric threshold comparison is evaluated for a plurality of candidate UE metric threshold values.

At 708, the method may include determining whether each slot name and each slot value is hallucinated based on the comparison between the UE metric calculated for each slot name and each slot value to the UE metric threshold value.

In at least one embodiment, if the UE metric type is set to be a Perplexity (PPL) UE metric type, a particular slot name or a particular slot value can be determined to be hallucinated if a PPL UE metric calculated for the particular slot name is greater than the UE metric threshold value or if a PPL UE metric calculated for the particular slot value is greater than the UE metric threshold value. In at least one embodiment, the UE metric threshold value for the PPL UE metric type may be between 1.0 and 9.0. In at least one embodiment, the UE metric threshold value for the PPL UE metric type may be set to 1.1.

In at least one embodiment, if UE metric type is a Length-normalized Sequence Probability (SeqProb-Normalized) UE metric type, a particular slot name or a particular slot value can be determined to be hallucinated if a SeqProb-Normalized UE metric calculated for the particular slot name is less than the UE metric threshold value or if a SeqProb-Normalized UE metric calculated for the particular slot value is less than the UE metric threshold value.

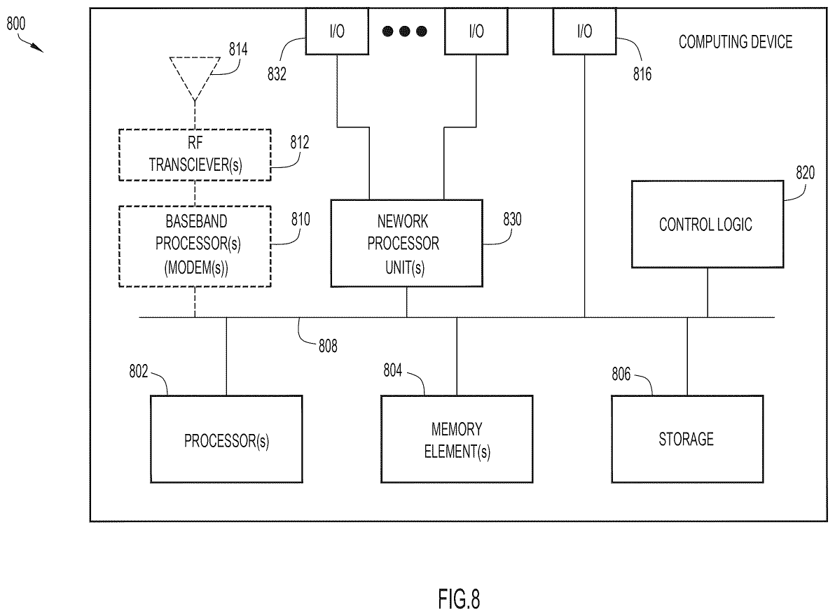

Referring to FIG. 8, FIG. 8 illustrates a hardware block diagram of a computing device 800 that may perform functions associated with operations discussed herein in connection with the techniques described for embodiments herein. In various embodiments, a computing device or apparatus, such as computing device 800 or any combination of computing devices 800, may be configured as any entity/entities in order to perform operations of the various techniques discussed for embodiments herein, such as any elements, functions, etc. discussed for embodiments herein (e.g., user device 104, function calling subsystem 120, LLM 150, etc.).

In at least one embodiment, the computing device 800 may be any apparatus that may include one or more processor(s) 802, one or more memory element(s) 804, storage 806, a bus 808, one or more network processor unit(s) 830 interconnected with one or more network input/output (I/O) interface(s) 832, one or more I/O interface(s) 816, and control logic 820. In various embodiments, instructions associated with logic for computing device 800 can overlap in any manner and are not limited to the specific allocation of instructions and/or operations described herein.

For embodiments in which computing device 800 may be implemented as any device capable of wireless communications, computing device 800 may further include at least one baseband processor or modem 810, one or more radio RF transceiver(s) 812 (e.g., any combination of RF receiver(s) and RF transmitter(s)), one or more antenna(s) or antenna array(s) 814.

In at least one embodiment, processor(s) 802 is/are at least one hardware processor configured to execute various tasks, operations and/or functions for computing device 800 as described herein according to software and/or instructions configured for computing device 800. Processor(s) 802 (e.g., a hardware processor) can execute any type of instructions associated with data to achieve the operations detailed herein. In one example, processor(s) 802 can transform an element or an article (e.g., data, information) from one state or thing to another state or thing. Any of potential processing elements, microprocessors, digital signal processor, baseband signal processor, modem, PHY, controllers, systems, managers, logic, and/or machines described herein can be construed as being encompassed within the broad term ‘processor’.

In at least one embodiment, memory element(s) 804 and/or storage 806 is/are configured to store data, information, software, and/or instructions associated with computing device 800, and/or logic configured for memory element(s) 804 and/or storage 806. For example, any logic described herein (e.g., control logic 820, which can include/be configured with function call logic 122 and hallucination detection logic 124) can, in various embodiments, be stored for computing device 800 using any combination of memory element(s) 804 and/or storage 806. Note that in some embodiments, storage 806 can be consolidated with memory element(s) 804 (or vice versa) or can overlap/exist in any other suitable manner.

In at least one embodiment, bus 808 can be configured as an interface that enables one or more elements of computing device 800 to communicate in order to exchange information and/or data. Bus 808 can be implemented with any architecture designed for passing control, data and/or information between processors, memory elements/storage, peripheral devices, and/or any other hardware and/or software components that may be configured for computing device 800. In at least one embodiment, bus 808 may be implemented as a fast kernel-hosted interconnect, potentially using shared memory between processes (e.g., logic), which can enable efficient communication paths between the processes.

In various embodiments, network processor unit(s) 830 may enable communication between computing device 800 and other systems, entities, etc., via network I/O interface(s) 832 (wired and/or wireless) to facilitate operations discussed for various embodiments described herein. In various embodiments, network processor unit(s) 830 can be configured as a combination of hardware and/or software, such as one or more Ethernet driver(s) and/or controller(s) or interface cards, Fibre Channel (e.g., optical) driver(s) and/or controller(s), wireless receivers/transmitters/transceivers, baseband processor(s)/modem(s), and/or other similar network interface driver(s) and/or controller(s) now known or hereafter developed to enable communications between computing device 800 and other systems, entities, etc. to facilitate operations for various embodiments described herein. In various embodiments, network I/O interface(s) 832 can be configured as one or more Ethernet port(s), Fibre Channel ports, any other I/O port(s), and/or antenna(s)/antenna array(s) now known or hereafter developed. Thus, the network processor unit(s) 830 and/or network I/O interface(s) 832 may include suitable interfaces for receiving, transmitting, and/or otherwise communicating data and/or information (wired and/or wirelessly) in a network environment.

I/O interface(s) 816 allow for input and output of data and/or information with other entities that may be connected to computing device 800. For example, I/O interface(s) 816 may provide a connection to external devices such as a keyboard, keypad, a touch screen, and/or any other suitable input and/or output device now known or hereafter developed. In some instances, external devices can also include portable computer readable (non-transitory) storage media such as database systems, thumb drives, portable optical or magnetic disks, and memory cards. In still some instances, external devices can be a mechanism to display data to a user, such as, for example, a computer monitor, a display screen, or the like.

For embodiments in which computing device 800 is implemented as a wireless device or any apparatus capable of wireless communications, the RF transceiver(s) 812 may perform RF transmission and RF reception of wireless signals via antenna(s)/antenna array(s) 814, and the baseband processor or modem 810 performs baseband modulation and demodulation, etc. associated with such signals to enable wireless communications for computing device 800.

In various embodiments, control logic 820, which can include/be configured with function call logic 122 and hallucination detection logic 124, can include instructions that, when executed, cause processor(s) 802 to perform operations, which can include, but not be limited to, providing overall control operations of computing device; interacting with other entities, systems, etc. described herein; maintaining and/or interacting with stored data, information, parameters, etc. (e.g., memory element(s), storage, data structures, databases, tables, etc.); combinations thereof; and/or the like to facilitate various operations for embodiments described herein.

The programs described herein (e.g., control logic 820, which can include/be configured with function call logic 122 and hallucination detection logic 124) may be identified based upon application(s) for which they are implemented in a specific embodiment. However, it should be appreciated that any particular program nomenclature herein is used merely for convenience; thus, embodiments herein should not be limited to use(s) solely described in any specific application(s) identified and/or implied by such nomenclature.

In various embodiments, any entity or apparatus as described herein may store data/information in any suitable volatile and/or non-volatile memory item (e.g., magnetic hard disk drive, solid state hard drive, semiconductor storage device, random access memory (RAM), read only memory (ROM), erasable programmable read only memory (EPROM), application specific integrated circuit (ASIC), etc.), software, logic (fixed logic, hardware logic, programmable logic, analog logic, digital logic), hardware, and/or in any other suitable component, device, element, and/or object as may be appropriate. Any of the memory items discussed herein should be construed as being encompassed within the broad term ‘memory element’. Data/information being tracked and/or sent to one or more entities as discussed herein could be provided in any database, table, register, list, cache, storage, and/or storage structure: all of which can be referenced at any suitable timeframe. Any such storage options may also be included within the broad term ‘memory element’ as used herein.

Note that in certain example implementations, operations as set forth herein may be implemented by logic encoded in one or more tangible media that is capable of storing instructions and/or digital information and may be inclusive of non-transitory tangible media and/or non-transitory computer readable storage media (e.g., embedded logic provided in: an ASIC, digital signal processing (DSP) instructions, software [potentially inclusive of object code and source code], etc.) for execution by one or more processor(s), and/or other similar machine, etc. Generally, memory element(s) 804 and/or storage 806 can store data, software, code, instructions (e.g., processor instructions), logic, parameters, combinations thereof, and/or the like used for operations described herein. This includes memory element(s) 804 and/or storage 806 being able to store data, software, code, instructions (e.g., processor instructions), logic, parameters, combinations thereof, or the like that are executed to carry out operations in accordance with teachings of the present disclosure.

In some instances, software of the present embodiments may be available via a non-transitory computer useable medium (e.g., magnetic or optical mediums, magneto-optic mediums, CD-ROM, DVD, memory devices, etc.) of a stationary or portable program product apparatus, downloadable file(s), file wrapper(s), object(s), package(s), container(s), and/or the like. In some instances, non-transitory computer readable storage media may also be removable. For example, a removable hard drive may be used for memory/storage in some implementations. Other examples may include optical and magnetic disks, thumb drives, and smart cards that can be inserted and/or otherwise connected to a network device for transfer onto another computer readable storage medium.

In one form, a computer-implemented method is provided that may include a computer-implemented method is provided that may include obtaining, from a large language model (LLM), function call text generated by the LLM and token information for one or more parameter slots of the function call text, wherein each parameter slot of the one or more parameter slots of the function call text includes a slot name and a slot value. The method may further include calculating an uncertainty estimator (UE) metric for each slot name and each slot value of the function call text based on a UE metric type and the token information and performing a comparison between the UE metric calculated for each slot name and each slot value to a UE metric threshold value. The UE metric threshold value can be determined based on the UE metric type and on an objective function that is defined to maximize percentages of slot values and slot names correctly predicted as non-hallucinations by a UE metric threshold comparison and to minimize percentages of slot values and slot names incorrectly predicted as non-hallucinations by the UE metric threshold comparison in which the UE metric threshold comparison is evaluated for a plurality of candidate UE metric threshold values. The method may further include determining whether each slot name and each slot value is hallucinated based on the comparison between the UE metric calculated for each slot name and each slot value to the UE metric threshold value.

In one instance, the UE metric type is a Perplexity (PPL) UE metric type and a particular slot name or a particular slot value can be determined to be hallucinated if a PPL UE metric calculated for the particular slot name is greater than the UE metric threshold value or if a PPL UE metric calculated for the particular slot value is greater than the UE metric threshold value. the UE metric threshold value is greater than 1 for the PPL UE metric type. In one instance, the UE metric threshold value is set to 1.1 for the PPL UE metric type.

In one instance, token information for the function call text is provided in a JavaScript Object Notation (JSON) object and includes a logarithmic probability for every token of each slot name and each slot value.

In one instance, the UE metric type is a Length-normalized Sequence Probability (SeqProb-Normalized) UE metric type and a particular slot name or a particular slot value can be determined to be hallucinated if a SeqProb-Normalized UE metric calculated for the particular slot name is less than the UE metric threshold value or if a SeqProb-Normalized UE metric calculated for the particular slot value is less than the UE metric threshold value.

In at least one instance, the method may include calculating, for a test data set comprising a plurality of function calls generated by the LLM, a corresponding objective function value for each candidate UE metric threshold value of the plurality of candidate UE metric threshold values based on a plurality of performance metrics to generate a plurality of objective function values. In at least one instance, the method may include identifying the UE metric threshold value based on identifying a maximum value among the plurality of objective function values.

In at least one instance, calculating the corresponding objective function value for each candidate UE metric threshold value of the plurality of candidate UE metric threshold values includes performing a plurality of UE metric threshold comparisons between each candidate UE metric threshold value and each of a particular UE metric calculated for each slot value of a plurality of slot values of the plurality of function calls of the test data set and a particular UE metric calculated for each slot name of a plurality of slot names of the plurality of function calls of the test data set to predict whether at least one of one or more particular slot names or one or more particular slot names have been hallucinated.

In at least one instance, the method may include, upon performing the plurality of UE metric threshold comparisons, calculating the corresponding objective function value for each candidate UE metric threshold value of the plurality of candidate UE metric threshold values includes calculating the plurality of performance metrics as: a percentage of correct slot names of the test data set that were correctly predicted to be non-hallucinations (% CSN); a percentage of correct slot values that were correctly predicted to be non-hallucinations (% CSV); a percentage of hallucinated slot names that were incorrectly predicted to be non-hallucinations (% WSN); a percentage of hallucinated slot values that were incorrectly predicted to be non-hallucinations (% WSV); and calculating the corresponding objective function value as % CSN+% CSV−% WSN−% WSV.

### Variations and Implementations

Embodiments described herein may include one or more networks, which can represent a series of points and/or network elements of interconnected communication paths for receiving and/or transmitting messages (e.g., packets of information) that propagate through the one or more networks. These network elements offer communicative interfaces that facilitate communications between the network elements. A network can include any number of hardware and/or software elements coupled to (and in communication with) each other through a communication medium. Such networks can include, but are not limited to, any local area network (LAN), virtual LAN (VLAN), wide area network (WAN) (e.g., the Internet), software defined WAN (SD-WAN), wireless local area (WLA) access network, wireless wide area (WWA) access network, metropolitan area network (MAN), Intranet, Extranet, virtual private network (VPN), Low Power Network (LPN), Low Power Wide Area Network (LPWAN), Machine to Machine (M2M) network, Internet of Things (IoT) network, Ethernet network/switching system, any other appropriate architecture and/or system that facilitates communications in a network environment, and/or any suitable combination thereof.

Networks through which communications propagate can use any suitable technologies for communications including wired communications (e.g., T1 lines, T3 lines, digital subscriber lines (DSL), Ethernet, Fibre Channel, etc.). Generally, any suitable means of communications may be used such as electric, sound, light, infrared, and/or radio to facilitate communications through one or more networks in accordance with embodiments herein. Communications, interactions, operations, etc. as discussed for various embodiments described herein may be performed among entities that may directly or indirectly connected utilizing any algorithms, communication protocols, interfaces, etc. (proprietary and/or non-proprietary) that allow for the exchange of data and/or information.

In various example implementations, any entity or apparatus for various embodiments described herein can encompass network elements (which can include virtualized network elements, functions, etc.) such as, for example, network appliances, forwarders, routers, servers, switches, gateways, bridges, loadbalancers, firewalls, processors, modules, radio receivers/transmitters, or any other suitable device, component, element, or object operable to exchange information that facilitates or otherwise helps to facilitate various operations in a network environment as described for various embodiments herein. Note that with the examples provided herein, interaction may be described in terms of one, two, three, or four entities. However, this has been done for purposes of clarity, simplicity and example only. The examples provided should not limit the scope or inhibit the broad teachings of systems, networks, etc. described herein as potentially applied to a myriad of other architectures.

Communications in a network environment can be referred to herein as ‘messages’, ‘messaging’, ‘signaling’, ‘data’, ‘content’, ‘objects’, ‘requests’, ‘queries’, ‘responses’, ‘replies’, etc. which may be inclusive of packets. As referred to herein and in the claims, the term ‘packet’ may be used in a generic sense to include packets, frames, segments, datagrams, and/or any other generic units that may be used to transmit communications in a network environment. Generally, a packet is a formatted unit of data that can contain control or routing information (e.g., source and destination address, source and destination port, etc.) and data, which is also sometimes referred to as a ‘payload’, ‘data payload’, and variations thereof. In some embodiments, control or routing information, management information, or the like can be included in packet fields, such as within header(s) and/or trailer(s) of packets. Internet Protocol (IP) addresses discussed herein and, in the claims, can include any IP version 4 (IPv4) and/or IP version 6 (IPv6) addresses.

To the extent that embodiments presented herein relate to the storage of data, the embodiments may employ any number of any conventional or other databases, data stores or storage structures (e.g., files, databases, data structures, data or other repositories, etc.) to store information.

Note that in this Specification, references to various features (e.g., elements, structures, nodes, modules, components, engines, logic, steps, operations, functions, characteristics, etc.) included in ‘one embodiment’, ‘example embodiment’, ‘an embodiment’, ‘another embodiment’, ‘certain embodiments’, ‘some embodiments’, ‘various embodiments’, ‘other embodiments’, ‘alternative embodiment’, and the like are intended to mean that any such features are included in one or more embodiments of the present disclosure, but may or may not necessarily be combined in the same embodiments. Note also that a module, engine, client, controller, function, service, logic or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

It is also noted that the operations and steps described with reference to the preceding figures illustrate only some of the possible scenarios that may be executed by one or more entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase ‘at least one of’, ‘one or more of’, ‘and/or’, variations thereof, or the like are open-ended expressions that are both conjunctive and disjunctive in operation for any and all possible combination of the associated listed items. For example, each of the expressions ‘at least one of X, Y and Z’, ‘at least one of X, Y or Z’, ‘one or more of X, Y and Z’, ‘one or more of X, Y or Z’ and ‘X, Y and/or Z’ can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Each example embodiment disclosed herein has been included to present one or more different features. However, all disclosed example embodiments are designed to work together as part of a single larger system or method. This disclosure explicitly envisions compound embodiments that combine multiple previously discussed features in different example embodiments into a single system or method.

Additionally, unless expressly stated to the contrary, the terms ‘first’, ‘second’, ‘third’, etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, ‘first X’ and ‘second X’ are intended to designate two ‘X’ elements that are not necessarily limited by any order, rank, importance, temporal sequence, or hierarchy of the two elements. Further as referred to herein, ‘at least one of’ and ‘one or more of can be represented using the’ (s)′ nomenclature (e.g., one or more element(s)).

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims.

What is claimed is:

1. A method comprising:
obtaining, from a large language model (LLM), function call text generated by the LLM and token information for one or more parameter slots of the function call text, wherein each parameter slot of the one or more parameter slots of the function call text includes a slot name and a slot value;
calculating an uncertainty estimator (UE) metric for each slot name and each slot value of the function call text based on a UE metric type and the token information;
performing a comparison between the UE metric calculated for each slot name and each slot value to a UE metric threshold value, wherein the UE metric threshold value is determined based on the UE metric type and on an objective function that is defined to maximize percentages of slot values and slot names correctly predicted as non-hallucinations by a UE metric threshold comparison and to minimize percentages of slot values and slot names incorrectly predicted as non-hallucinations by the UE metric threshold comparison in which the UE metric threshold comparison is evaluated for a plurality of candidate UE metric threshold values; and
determining whether each slot name and each slot value is hallucinated based on the comparison between the UE metric calculated for each slot name and each slot value to the UE metric threshold value.

2. The method of claim 1, wherein the UE metric type is a Perplexity (PPL) UE metric type and a particular slot name or a particular slot value is determined to be hallucinated if a PPL UE metric calculated for the particular slot name is greater than the UE metric threshold value or if a PPL UE metric calculated for the particular slot value is greater than the UE metric threshold value.

3. The method of claim 2, wherein the UE metric threshold value is greater than 1.0.

4. The method of claim 2, wherein the UE metric threshold value is 1.1.

5. The method of claim 1, wherein the token information for the function call text is provided in a JavaScript Object Notation (JSON) object and includes a logarithmic probability for every token of each slot name and each slot value.

6. The method of claim 1, wherein the UE metric type is a Length-normalized Sequence Probability (SeqProb-Normalized) UE metric type and a particular slot name or a particular slot value is determined to be hallucinated if a SeqProb-Normalized UE metric calculated for the particular slot name is less than the UE metric threshold value or if a SeqProb-Normalized UE metric calculated for the particular slot value is less than the UE metric threshold value.

7. The method of claim 1, further comprising:
calculating, for a test data set comprising a plurality of function calls generated by the LLM, a corresponding objective function value for each candidate UE metric threshold value of the plurality of candidate UE metric threshold values based on a plurality of performance metrics to generate a plurality of objective function values.

8. The method of claim 7, further comprising:
identifying the UE metric threshold value based on identifying a maximum value among the plurality of objective function values.

9. The method of claim 7, wherein calculating the corresponding objective function value for each candidate UE metric threshold value of the plurality of candidate UE metric threshold values includes performing a plurality of UE metric threshold comparisons between each candidate UE metric threshold value and each of a particular UE metric calculated for each slot value of a plurality of slot values of the plurality of function calls of the test data set and a particular UE metric calculated for each slot name of a plurality of slot names of the plurality of function calls of the test data set to predict whether at least one of one or more particular slot names or one or more particular slot names have been hallucinated.

10. The method of claim 9, further comprising:
upon performing the plurality of UE metric threshold comparisons, calculating the corresponding objective function value for each candidate UE metric threshold value of the plurality of candidate UE metric threshold values includes calculating the performance metrics as:
a percentage of correct slot names of the test data set that were correctly predicted to be non-hallucinations (% CSN);
a percentage of correct slot values that were correctly predicted to be non-hallucinations (% CSV);
a percentage of hallucinated slot names that were incorrectly predicted to be non-hallucinations (% WSN);
a percentage of hallucinated slot values that were incorrectly predicted to be non-hallucinations (% WSV); and
calculating the corresponding objective function value as % CSN+% CSV−% WSN−% WSV.

11. One or more non-transitory computer readable storage media encoded with instructions that, when executed by a processor, cause the processor to perform operations, comprising:
obtaining, from a large language model (LLM), function call text generated by the LLM and token information for one or more parameter slots of the function call text, wherein each parameter slot of the one or more parameter slots of the function call text includes a slot name and a slot value;
calculating an uncertainty estimator (UE) metric for each slot name and each slot value of the function call text based on a UE metric type and the token information;
performing a comparison between the UE metric calculated for each slot name and each slot value to a UE metric threshold value, wherein the UE metric threshold value is determined based on the UE metric type and on an objective function that is defined to maximize percentages of slot values and slot names correctly predicted as non-hallucinations by a UE metric threshold comparison and to minimize percentages of slot values and slot names incorrectly predicted as non-hallucinations by the UE metric threshold comparison in which the UE metric threshold comparison is evaluated for a plurality of candidate UE metric threshold values; and
determining whether each slot name and each slot value is hallucinated based on the comparison between the UE metric calculated for each slot name and each slot value to the UE metric threshold value.

12. The media of claim 11, wherein the UE metric type is a Perplexity (PPL) UE metric type and a particular slot name or a particular slot value is determined to be hallucinated if a PPL UE metric calculated for the particular slot name is greater than the UE metric threshold value or if a PPL UE metric calculated for the particular slot value is greater than the UE metric threshold value.

13. The media of claim 11, wherein the UE metric type is a Length-normalized Sequence Probability (SeqProb-Normalized) UE metric type and a particular slot name or a particular slot value is determined to be hallucinated if a SeqProb-Normalized UE metric calculated for the particular slot name is less than the UE metric threshold value or if a SeqProb-Normalized UE metric calculated for the particular slot value is less than the UE metric threshold value.

14. The media of claim 11, wherein the instructions, when executed by a processor, cause the processor to perform further operations, comprising:
calculating, for a test data set comprising a plurality of function calls generated by the LLM, a corresponding objective function value for each candidate UE metric threshold value of the plurality of candidate UE metric threshold values based on a plurality of performance metrics to generate a plurality of objective function values; and
identifying the UE metric threshold value based on identifying a maximum value among the plurality of objective function values.

15. A system comprising:
at least one memory element for storing data; and
at least one processor for executing instructions associated with the data, wherein executing the instructions causes the system to perform operations, comprising:
obtaining, from a large language model (LLM), function call text generated by the LLM and token information for one or more parameter slots of the function call text, wherein each parameter slot of the one or more parameter slots of the function call text includes a slot name and a slot value;
calculating an uncertainty estimator (UE) metric for each slot name and each slot value of the function call text based on a UE metric type and the token information;
performing a comparison between the UE metric calculated for each slot name and each slot value to a UE metric threshold value, wherein the UE metric threshold value is determined based on the UE metric type and on an objective function that is defined to maximize percentages of slot values and slot names correctly predicted as non-hallucinations by a UE metric threshold comparison and to minimize percentages of slot values and slot names incorrectly predicted as non-hallucinations by the UE metric threshold comparison in which the UE metric threshold comparison is evaluated for a plurality of candidate UE metric threshold values; and
determining whether each slot name and each slot value is hallucinated based on the comparison between the UE metric calculated for each slot name and each slot value to the UE metric threshold value.

16. The system of claim 15, wherein the UE metric type is a Perplexity (PPL) UE metric type and a particular slot name or a particular slot value is determined to be hallucinated if a PPL UE metric calculated for the particular slot name is greater than the UE metric threshold value or if a PPL UE metric calculated for the particular slot value is greater than the UE metric threshold value.

17. The system of claim 16, wherein the UE metric threshold value is greater than 1.0.

18. The system of claim 15, wherein the UE metric type is a Length-normalized Sequence Probability (SeqProb-Normalized) UE metric type and a particular slot name or a particular slot value is determined to be hallucinated if a SeqProb-Normalized UE metric calculated for the particular slot name is less than the UE metric threshold value or if a SeqProb-Normalized UE metric calculated for the particular slot value is less than the UE metric threshold value.

19. The system of claim 15, wherein executing the instructions causes the system to perform further operations, comprising:
calculating, for a test data set comprising a plurality of function calls generated by the LLM, a corresponding objective function value for each candidate UE metric threshold value of the plurality of candidate UE metric threshold values based on a plurality of performance metrics to generate a plurality of objective function values.

20. The system of claim 19, wherein executing the instructions causes the system to perform further operations, comprising:
identifying the UE metric threshold value based on identifying a maximum value among the plurality of objective function values.
